(19) United States
(12) Patent Application Publication
(10) Pub. No.: US 2026/0107357 A1
(43) Pub. Date: Apr. 16, 2026

(54) CONTROL SYSTEM FOR LIGHT EMITTING DEVICE WITH TEMPERATURE COMPENSATION FUNCTION

(71) Applicant: ANAX TECHNOLOGY CORP., Zhubei City (TW)

(72) Inventors: Li-Lun CHI, Zhubei City (TW); Hung-Cheng CHANG, Zhubei City (TW); Chih-Chang WEI, Zhubei City (TW); Ping-Yuan LIN, Zhubei City (TW); Jyun-Long LIN, Zhubei City (TW)

(73) Assignee: ANAX TECHNOLOGY CORP., Zhubei City (TW)

(21) Appl. No.: 19/338,188

(22) Filed: Sep. 24, 2025

Related U.S. Application Data
(60) Provisional application No. 63/707,907, filed on Oct. 16, 2024.

(51) Int. Cl. H05B 45/18

(52) U.S. Cl. CPC H05B 45/18

(57) ABSTRACT

A control system for a light emitting device with temperature compensation function includes a control circuit and a drive circuit string. The control circuit is configured to generate N number of brightness data sets, where N>1. The drive circuit string includes M number of functional circuits that include N number of drive circuits corresponding respectively to the N number of brightness data sets, and at least one temperature sensing circuit configured to output at least one temperature value, where M>N. The control circuit is configured to adjust P number of brightness data set(s) among the N number of brightness data sets based on the temperature value, and transmit the N number of brightness data sets thus adjusted respectively to the N number of drive circuits for driving the N number of light emitting components to emit light, where N≥P.

### CROSS-REFERENCE TO RELATED APPLICATION

This application claims the benefit of U.S. Provisional Patent Application No. 63/707,907, filed on Oct. 16, 2024, the entire disclosure of which is incorporated by reference herein.

### FIELD

The disclosure relates to a control system, and more particularly to a control system for a light emitting device with temperature compensation function.

### BACKGROUND

Referring to FIG. 1, a conventional control system for a light emitting device includes a control circuit (C1), and a plurality of drive circuits (D1 to DN) that are connected in series. The control circuit (C1) includes a control terminal (CTRL) configured to output a command signal data packet (e.g., an address setting data packet and a brightness control data packet), and a feedback terminal (FEB). Each of the drive circuits (D1 to DN) includes an input terminal (IN) and an output terminal (OUT). The input terminal (IN) of a first one of the drive circuits (D1 to DN) is electrically connected to the control terminal (CTRL) of the control circuit (C1). The output terminal (OUT) of a last one of the drive circuits (D1 to DN) is electrically connected to the feedback terminal (FEB) of the control circuit (C1). The control circuit (C1) transmits the command signal data packet to the drive circuits (D1 to DN) through the input terminal (IN) and the output terminal (OUT) of each of the drive circuits (D1 to DN) for address setting of the drive circuits (D1 to DN) (i.e., the command signal data packet being the address setting data packet), and for transmitting brightness data to the drive circuits (D1 to DN) (i.e., the command signal data packet being the brightness control data packet, and the brightness control data packet including the brightness data). The drive circuits (D1 to DN) are electrically connected respectively to a plurality of light emitting components (L1). Each of the drive circuits (D1 to DN) is configured to drive a corresponding one of the light emitting components (L1) to emit light based on the brightness data received from the control circuit (C1).

When a temperature sensor needs to be added amongst the drive circuits (D1 to DN), one conventional approach is to use additional wiring and additional circuit board layers to accommodate the temperature sensor, which increases wiring complexity. Another conventional approach is to use drive circuits that are integrated with temperature sensing functionality. However, such drive circuits may suffer from reduced temperature sensing accuracy due to load variations, and may be larger in size, which may reduce flexibility of a circuit board layout of the conventional control system.

### SUMMARY

Therefore, an object of the disclosure is to provide a control system for a light emitting device with temperature compensation function that can alleviate at least one of the drawbacks of the prior art.

According to an aspect of the disclosure, the control system includes a control circuit and a drive circuit string. The control circuit includes a control terminal, and is configured to receive display data from a signal source, and generate N number of brightness data sets that correspond respectively to N number of light emitting components based on the display data thus received, where N>1. The drive circuit string includes M number of functional circuits, where M is a positive integer, and M>N. The M number of functional circuits include N number of drive circuits, and at least one temperature sensing circuit. The N number of drive circuits correspond respectively to the N number of brightness data sets, and are configured to respectively drive the N number of light emitting components. The at least one temperature sensing circuit is configured to output at least one temperature value, each of which indicates a temperature of a surrounding in which a corresponding one of the at least one temperature sensing circuit is placed. Each of the N number of drive circuits and the at least one temperature sensing circuit is one of the M number of functional circuits. P number of drive circuit(s) among the N number of drive circuits correspond to the at least one temperature sensing circuit, where P is a positive integer, and N≥P.

Each of the M number of functional circuits includes a first terminal and a second terminal. The M number of functional circuits are sequentially connected in series via the first terminal and the second terminal of each of the M number of functional circuits. The first terminal of a first one of the M number of functional circuits is electrically connected to the control terminal. The control circuit is further configured to receive the at least one temperature value from the temperature sensing circuit of the drive circuit string, adjust P number of brightness data set(s) among the N number of brightness data sets based on the at least one temperature value thus received, and transmit the N number of brightness data sets including the P number of brightness data set(s) that have been adjusted to the N number of drive circuits in order for the N number of drive circuits to respectively drive the N number of light emitting components to emit light based on the N number of brightness data sets. The P number of brightness data set(s) correspond respectively to the P number of drive circuit(s).

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a conventional control system for a light emitting device.

FIG. 2 is a block diagram illustrating a control system for a light emitting device with temperature compensation function according to a first embodiment of the disclosure.

FIG. 3 is a block diagram illustrating a drive circuit according to the first embodiment of the disclosure.

FIG. 4 is a block diagram illustrating a temperature sensing circuit according to the first embodiment of the disclosure.

FIG. 5 is a diagram illustrating a packet format of an address setting data packet.

FIG. 6 is a timing diagram illustrating a starting address setting signal and address setting output signals respectively outputted by a control circuit and a plurality of drive circuits according to the first embodiment of the disclosure.

FIG. 7 is a diagram illustrating a packet format of a data fetch data packet of a data fetch request signal.

FIG. 8 is a diagram illustrating a packet format of a data fetch data packet of a temperature fetch signal.

FIG. 9 is a diagram illustrating a packet format of a data response data packet.

FIG. 10 is a diagram illustrating a packet format of a temperature response data packet.

FIG. 11 is a diagram illustrating a packet format of a brightness data packet.

FIG. 12 is a graph illustrating a relationship between a luminance and a temperature of light emitting components under a constant driving current.

FIG. 13 is a graph illustrating a relationship between a calibration factor and a temperature of the light emitting components.

FIG. 14 is a diagram illustrating an example of the brightness data packet when a first method of address setting is used.

FIG. 15 is a diagram illustrating an example of the brightness data packet when a second method of address setting is used.

FIG. 16 is a block diagram illustrating the control system for a light emitting device with temperature compensation function according to a second embodiment of the disclosure.

FIG. 17 is a block diagram illustrating the drive circuit according to the second embodiment of the disclosure.

FIG. 18 is a block diagram illustrating the temperature sensing circuit according to the second embodiment of the disclosure.

FIG. 19 is a block diagram illustrating a pass-through signal transmission path according to the second embodiment of the disclosure.

FIG. 20 is a timing diagram illustrating transmission of brightness control signals according to the second embodiment of the present disclosure.

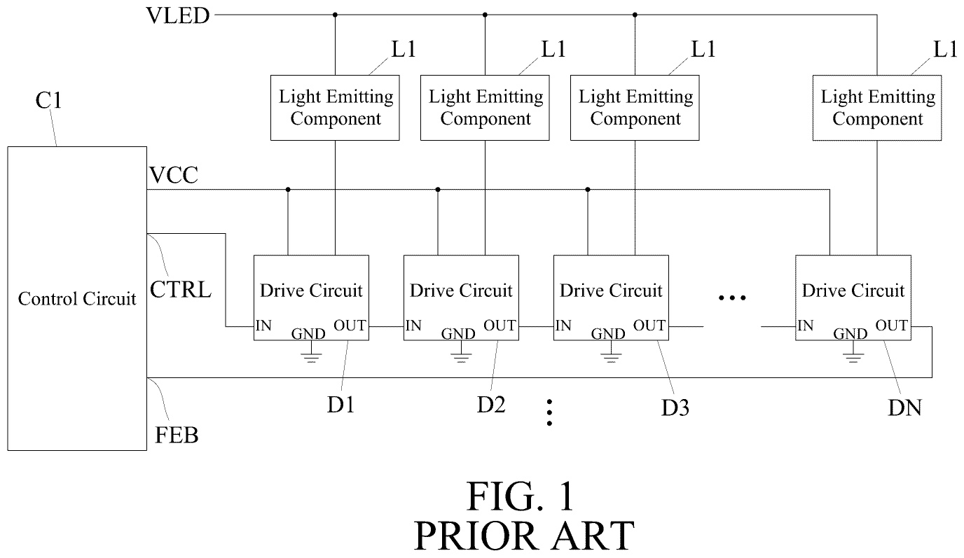

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

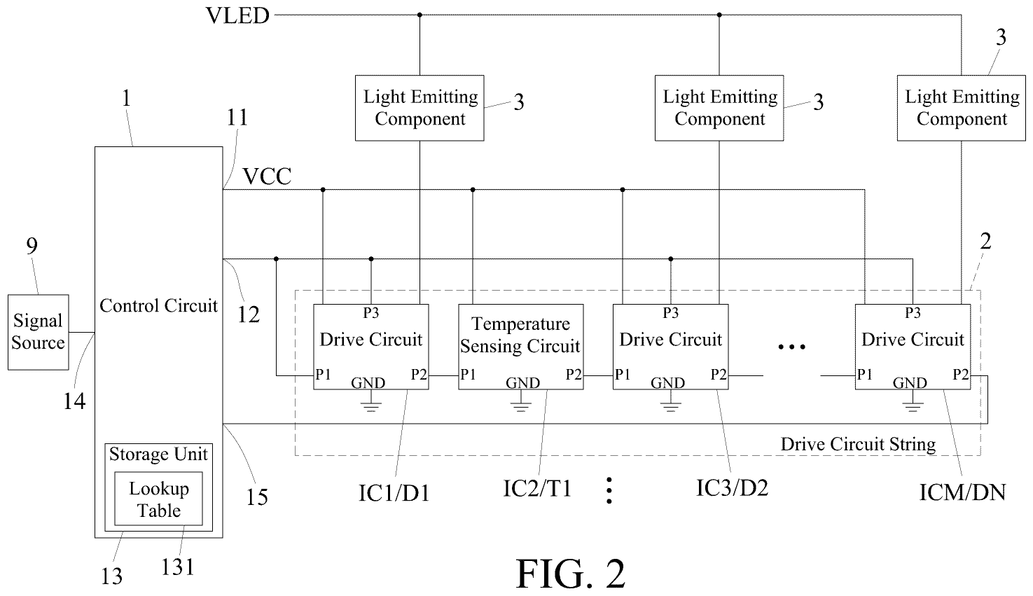

Referring to FIG. 2, a control system for a light emitting device with temperature compensation function according to a first embodiment of the disclosure is used to drive N number of light emitting components 3 (e.g., light emitting diode (LED) components of a backlight module of a liquid crystal display (LCD) panel), where N is a positive integer, and N>1. The control system includes a control circuit 1, and at least one drive circuit string 2. For ease of illustration, the number of drive circuit strings 2 is one, for example.

The control circuit 1 includes a power source terminal 11 for outputting an operating voltage (VCC), a control terminal 12 configured to output a starting address setting signal, a brightness control signal or a data fetch signal, a storage unit 13 that stores a lookup table 131, a signal receiving terminal 14 electrically connected to a signal source 9 (e.g., a display chip for a computer or a television), and a feedback terminal 15. The control circuit 1 is configured to receive display data from the signal source 9 via the signal receiving terminal 14, and generate N number of brightness data sets that correspond respectively to the N number of light emitting components 3 based on the display data thus received. The lookup table 131 of the storage unit 13 includes a plurality of calibration factors, and a plurality of reference temperatures that correspond respectively to the calibration factors. The control circuit 1 is further configured to make adjustments on the N number of brightness data sets thus generated based on the lookup table 131.

The drive circuit string 2 includes M number of functional circuits (IC1 to ICM), each including a first terminal (P1) and a second terminal (P2), where M is a positive integer, and M>N. The functional circuits (IC1 to ICM) are sequentially connected in series via the first terminal (P1) and the second terminal (P2) of each of the functional circuits (IC1 to ICM). For example, for each positive integer m such that 2≤m≤M, the first terminal (P1) of an m^{th} one of the functional circuits (IC1 to ICM) (hereinafter referred to as “the m^{th} functional circuit (ICm)”) is electrically connected to the second terminal (P2) of an (m−1)^{th} one of the functional circuits (IC1 to ICM) (hereinafter referred to as “the (m−1)^{th} functional circuit (IC(m−1)”). The first terminal (P1) of a first one of the functional circuits (IC1 to ICM) (hereinafter referred to as “the first functional circuit (IC1)”) is electrically connected to the control terminal 12 of the control circuit 1. In this embodiment, the functional circuits (IC1 to ICM) include N number of drive circuits (D1 to DN) configured to respectively drive the N number of light emitting components 3, and a temperature sensing circuit (T1). Each of the drive circuits (D1 to DN) and the temperature sensing circuit (T1) is one of the functional circuits (IC1 to ICM). The temperature sensing circuit (T1) is configured to output a temperature value that indicates a temperature of a surrounding in which the temperature sensing circuit (T1) is placed. It should be noted that, a number of the temperature sensing circuit (T1) and a position of the temperature sensing circuit (T1) connected in series with the drive circuits (D1 to DN) may vary according to design requirements. In some embodiments, in order to measure the temperature at different locations of the drive circuit string 2, the drive circuit string 2 may include a plurality of temperature sensing circuits (T1 to TK) respectively outputting a plurality of temperature values, where 1<K≤M. In such embodiments, each of the drive circuits (D1 to DN) and the temperature sensing circuits (T1 to TK) is one of the functional circuits (IC1 to ICM). In this embodiment, for example, the temperature sensing circuit (T1) is connected in series between a first one of the drive circuits (D1 to DN) (hereinafter referred to as “the first drive circuit (D1))” and a second one of the drive circuits (D1 to DN) (hereinafter referred to as “the second drive circuit (D2)”), but the position in which the temperature sensing circuit (T1) is placed is not limited to such. In other embodiments, the position of the temperature sensing circuit (T1) may be before or after any one of the drive circuits (D1 to DN). That is to say, in those other embodiments, the temperature sensing circuit (T1) may be any one of the functional circuits (IC1 to ICM).

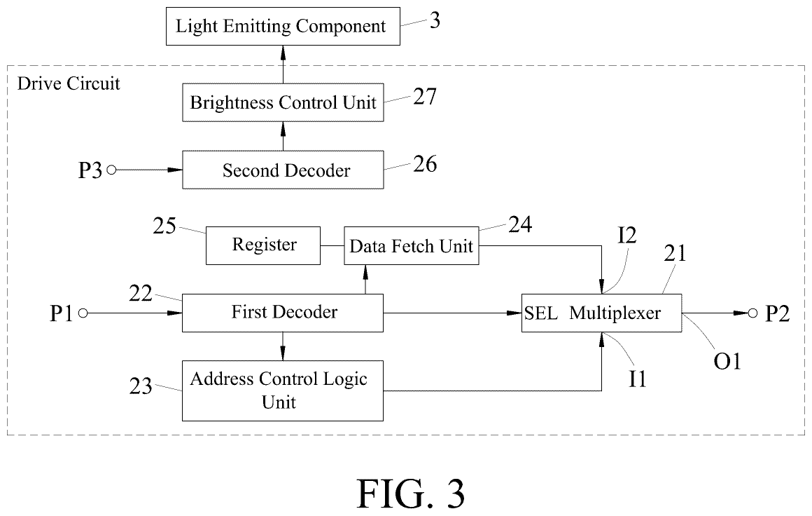

Further referring to FIG. 3, aside from including the first terminal (P1) and the second terminal (P2), each of the drive circuits (D1 to DN) further includes a third terminal (P3) electrically connected to the control terminal 12 of the control circuit 1, a multiplexer 21, a first decoder 22 electrically connected to the first terminal (P1), an address control logic unit 23, a data fetch unit 24, a register 25 that stores internal data (e.g., brightness data, a voltage margin, and an LED open/short circuit status of the corresponding one of the light emitting components 3) of the drive circuit, a second decoder 26 electrically connected to the third terminal (P3), and a brightness control unit 27.

The multiplexer 21 includes a first input terminal (I1), a second input terminal (I2), a select terminal (SEL), and a signal output terminal (O1) that is electrically connected to the second terminal (P2) of the drive circuit. The multiplexer 21 is configured to select a signal from the first input terminal (I1) or the second input terminal (I2) to be transmitted to the signal output terminal (O1) based on a select signal received by the select terminal (SEL). The address control logic unit 23 is electrically connected to the first decoder 22, and the first input terminal (I1) of the multiplexer 21. The data fetch unit 24 is electrically connected to the register 25, the first decoder 22, and the second input terminal (I2) of the multiplexer 21. The brightness control unit 27 is electrically connected to the second decoder 26, and a corresponding one of the light emitting components 3. The brightness control unit 27 is configured to generate a driving current, and transmit the driving current to the corresponding one of the light emitting components 3 to drive the corresponding one of the light emitting components 3 to emit light based on the driving current. In some embodiments, the brightness control unit 27 may include, for example, a digital-to-analog converter (DAC), a voltage-to-current (V/I) converter, a current driving circuit, a pulse width modulation (PWM) circuit, or a combination thereof, but the brightness control unit 27 is not limited in this respect.

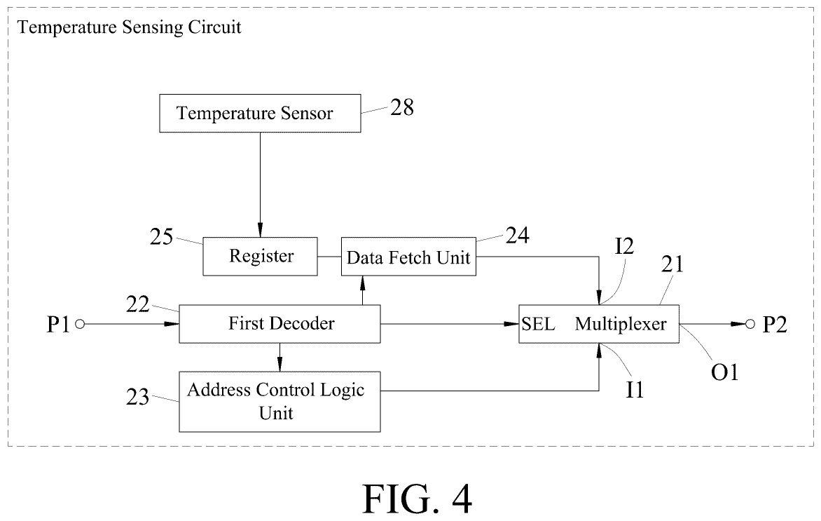

Further referring to FIG. 4, aside from including the first terminal (P1) and the second terminal (P2), the temperature sensing circuit (T1) further includes a multiplexer 21, a first decoder 22 electrically connected to the first terminal (P1), an address control logic unit 23, a data fetch unit 24, a register 25 that stores internal data (e.g., temperature data) of the temperature sensing circuit (T1), and a temperature sensor 28. Since electrical connections amongst the multiplexer 21, the first decoder 22, the address control logic unit 23, the data fetch unit 24, and the register 25 are similar to those of the drive circuits (D1 to DN) mentioned above, further illustrations thereof will be omitted for the sake of brevity. The temperature sensor 28 is electrically connected to the register 25, and is configured to sense the temperature of the surroundings, and transmit the temperature value thus sensed to the register 25 to be stored therein.

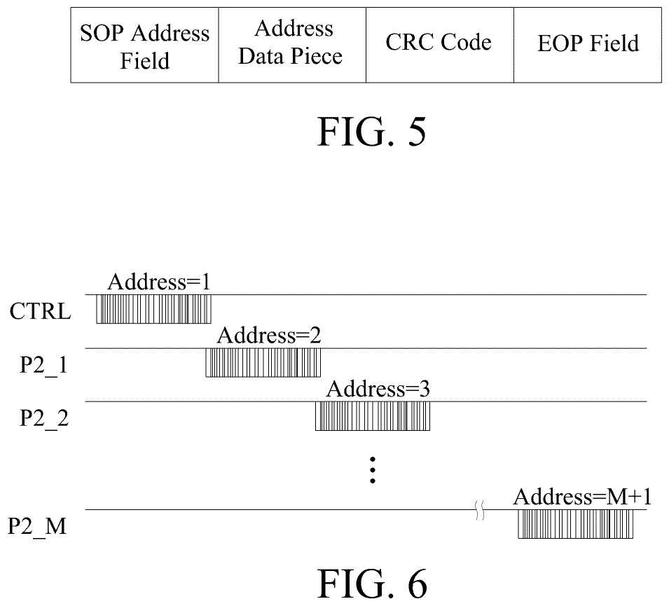

An address setting operation of the control system of the disclosure is described below. When the control circuit 1 transmits a starting address setting signal to the drive circuit string 2 via the control terminal 12, the first decoder 22 of the first functional circuit (IC1) receives the starting address setting signal via the first terminal (P1) of the first functional circuit (IC1). In this embodiment, the starting address setting signal includes an address setting data packet, but the disclosure is not limited in this respect. A packet format of the address setting data packet is exemplarily shown in FIG. 5, and includes a Start of Packet (SOP) field for address setting (referred to as “SOP address field”) that indicates a start of an address-type data packet, an address data piece that indicates an input setting address, a Cyclic Redundancy Check (CRC) code, and an End of Packet (EOP) field. In the address setting data packet of the starting address setting signal, the input setting address is a preset starting address (e.g., address=1, but not limited to 1). The drive circuit string 2 is configured to, in response to receipt of the starting address setting signal, sequentially set an assigned address for each of the functional circuits (IC1 to ICM) based on the preset starting address included in the starting address setting signal. In one embodiment, for each positive integer i such that 1≤i≤M, an i^{th} one of the functional circuits (IC1 to ICM) (hereinafter referred to as “the i^{th} functional circuit (ICi)”) is configured to, in response to receipt of a signal that includes the address setting data packet (hereinafter referred to as “the address setting input signal”) via the first terminal (P1) of the i^{th} functional circuit (ICi), set the assigned address of the i^{th} functional circuit (ICi) based on the input setting address, obtain an output setting address based on the input setting address, generate another signal that includes the output setting address (hereinafter referred to as “the address setting output signal”), and output the address setting output signal to the second terminal (P2) of the i^{th} functional circuit (ICi). For the m^{th} functional circuit (ICm), the address setting output signal outputted by the (m−1)^{th} functional circuit (IC(m−1)) serves as the address setting input signal that is to be received by the first terminal (P1) of the m^{th} functional circuit (ICm), and the output setting address included in the address setting output signal outputted by the (m−1)^{th} functional circuit (IC(m−1)) serves as the input setting address for setting the assigned address of the m^{th} functional circuit (ICm). By virtue of the aforementioned arrangement, the drive circuit string 2 sequentially sets the assigned address for each of the functional circuits (IC1 to ICM).

Using the first functional circuit (IC1) (i.e., the first drive circuit (D1) in FIG. 2) as an example, the starting address setting signal outputted by the control circuit 1 via the control terminal 12 serves as the address setting input signal (referred to as a first address setting input signal) that is to be received by the first terminal (P1) of the first functional circuit (IC1). Specifically, the first decoder 22 of the first functional circuit (IC1) receives the starting address setting signal through the first terminal (P1) of the first functional circuit (IC1). The first decoder 22 then decodes the starting address setting signal, determines that the starting address setting signal includes the address setting data packet and is to be used for address setting based on the SOP address field, and performs a CRC verification on the starting address setting signal. If the CRC verification is successful, the first decoder 22 of the first functional circuit (IC1) transmits the starting address setting signal thus decoded to the address control logic unit 23, and generates and transmits a select signal to the multiplexer 21 to cause the multiplexer 21 to transmit a signal received from the address control logic unit 23 which is to be transmitted to the second terminal (P2) of the first functional circuit (IC1). This means that the multiplexer 21 transmits the signal from the first input terminal (I1) to the signal output terminal (O1).

In this embodiment, different methods may be used for setting the assigned address for each of the functional circuits (IC1 to ICM). In a first method of address setting, for each positive integer i such that 1≤i≤M, the address control logic unit 23 of the i^{th} functional circuit (ICi) (i.e., the functional circuits (IC1 to ICM) including the drive circuits (D1 to DN) and the temperature sensing circuit (T1)), in response to receipt of the address setting input signal (e.g., for the first functional circuit (IC1) is the starting address setting signal), sets the input setting address (e.g., for the first functional circuit (IC1) is the preset starting address that is 1 in this method) included in the address setting input signal as the assigned address of the i^{th} functional circuit (ICi). The address control logic unit 23 then obtains the output setting address for the i^{th} functional circuit (ICi) by adding a first preset value (e.g., 1 in this method) to the input setting address, generates the address setting output signal that includes the output setting address, and outputs the address setting output signal to the multiplexer 21. By virtue of this arrangement, the assigned addresses respectively of the functional circuits (IC1 to ICM) are set in sequence, and the assigned addresses present an arithmetic sequence with an increment of the first preset value. In this method, the N number of brightness data sets correspond respectively to the assigned addresses respectively of the drive circuits (D1 to DN), and the assigned address of the i^{th} functional circuit (ICi) is equal to the preset starting address plus the first preset value multiplied by (i−1). For example, when the preset starting address is 1, and the first preset value is 1, the assigned addresses respectively of the functional circuits (IC1 to ICM) are 1, 2, 3, to M.

Referring to FIG. 6, “CTRL” denotes a signal that is transmitted from the control circuit 1 to the first functional circuit (IC1), and “P2_1”, “P2_2”, and “P2_M” denote signals that are outputted by the second terminals (P2) respectively of the first functional circuit (IC1), and a second one of the functional circuits (IC1 to ICM) (hereinafter referred to as “the second functional circuit (IC2)”) to a last one of the functional circuits (IC1 to ICM) (hereinafter referred to as “the last functional circuit (ICM)”). The second functional circuit (IC2) (e.g., the temperature sensing circuit (T1) in FIG. 2) receives the address setting output signal (referred to as a first address setting output signal) generated by the first functional circuit (IC1) (e.g., the first drive circuit (D1) in FIG. 2) as the address setting input signal for the second functional circuit (IC2) (referred to as a second address setting input signal). If the CRC verification is successful, the second functional circuit (IC2), performs operations similar to that of the first functional circuit (IC1) when the first functional circuit (IC1) receives the starting address setting signal. The second functional circuit (IC2) then adds the first preset value to the input setting address included in the second address setting input signal (e.g., address=2 (input setting address)+1 (first preset value)=3), and generates a second address setting output signal (see the signal on P2_2 in FIG. 6) that is transmitted from the second terminal (P2) of the second functional circuit (IC2) to the first terminal (P1) of a next one of the functional circuits (IC1 to ICM) (i.e., a third one of the functional circuits (IC1 to ICM), namely, a second one of the drive circuits (D1 to DN) in FIG. 2). In other words, the address setting output signal that is outputted by the i^{th} functional circuit (ICi) serves as the address setting input signal of an (i+1)^{th} one of the functional circuits (IC1 to ICM), and the output setting address that is included in the address setting output signal of the i^{th} functional circuit (ICi) serves as the input setting address of the address setting input signal of the (i+1)^{th} one of the functional circuits (IC1 to ICM).

In a second method of address setting, for each positive integer i such that 1≤i≤M, the i^{th} functional circuit (ICi) is configured to, in a case where the i^{th} functional circuit (ICi) is a temperature sensing circuit, obtain a temperature setting address by adding a second preset value to the input setting address, set the assigned address of the i^{th} functional circuit (ICi) based on the temperature setting address, and obtain the output setting address by setting the input setting address as the output setting address. In the second method, the temperature sensing circuit (T1), in response to receipt of the address setting input signal, obtains the temperature setting address by adding the second preset value to the input setting address included in the address setting input signal thus received, sets the temperature setting address as the assigned address of the temperature sensing circuit (T1), and obtains the output setting address for the temperature sensing circuit (T1) by setting the input setting address as the output setting address. In this second method, the second preset value can be a positive integer of any value, and this disclosure is not limited in this respect. For example, when the input setting address of the address setting input signal is 2, and the second preset value is 10, the assigned address of the temperature sensing circuit (T1) is set to be 12 (i.e., 2+10=12). The temperature sensing circuit (T1) then generates an address setting output signal that includes the input setting address of 2. That is to say, the output setting address that is outputted by the temperature sensing circuit (T1) to a next one of the functional circuits (IC1 to ICM) is the same as the input setting address that is received by the temperature sensing circuit (T1).

The i^{th} functional circuit (ICi) is configured to, in a case where the i^{th} functional circuit (ICi) is one of the drive circuits (D1 to DN), set the assigned address of the i^{th} functional circuit (ICi) based on the input setting address included in the address setting input signal thus received, and obtain the output setting address by adding the first preset value to the input setting address. Therefore, when the setting of the assigned address of each of the functional circuits (IC1 to ICM) is completed according to the second method, assigned addresses respectively of the drive circuits (D1 to DN) form another arithmetic sequence with an increment of the first preset value, and the assigned address of the temperature sensing circuit (T1) may be the same as the assigned address of one of the drive circuits (D1 to DN) or may be greater than the assigned addresses of some of the drive circuits (D1 to DN) depending on the second preset value, the position of the temperature sensing circuit (T1) in the drive circuit string 2, and a number of the drive circuits (D1 to DN), but the disclosure is not limited in this respect. Referring to FIG. 2, when the preset starting address is 1 (i.e., the assigned address of the first drive circuit (D1) is 1), and both of the first preset value and the second preset value are 1, the assigned addresses of the drive circuits (D1 to DN) are respectively 1, 2, 3, to N, and the assigned address of the temperature sensing circuit (T1) is 3, which is the same as the assigned address of a third one of the drive circuits (D1 to DN) (hereinafter referred to as “the third drive circuit (D3)”).

A data fetch operation of the first embodiment of the control system of the disclosure is described below. When the control circuit 1 wants to fetch internal data from one of the functional circuits (IC1 to ICM), the control circuit 1 transmits a data fetch signal to the first functional circuit (IC1) via the control terminal 12.

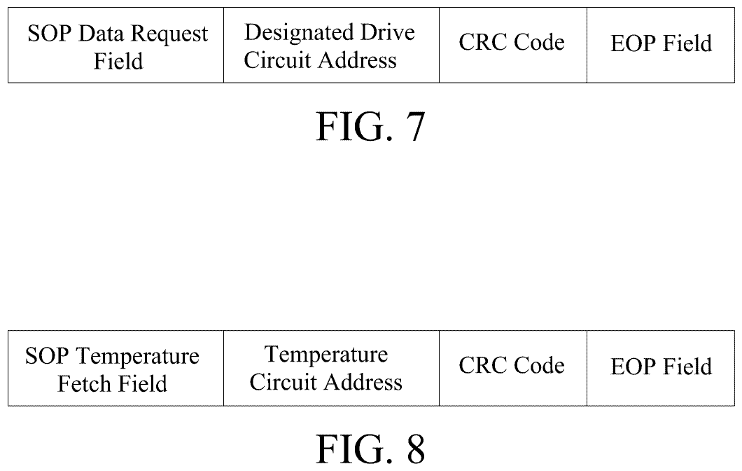

The data fetch signal may be a data fetch request signal that corresponds to the drive circuits (D1 to DN), or a temperature fetch signal that corresponds to the temperature sensing circuit (T1). In this embodiment, each of the data fetch request signal and the temperature fetch signal includes a data fetch data packet, but the disclosure is not limited in this respect. Referring to FIG. 7, the data fetch data packet of the data fetch request signal includes an SOP field for data fetch request of the drive circuits (D1 to DN) or for obtaining internal data respectively of the drive circuits (D1 to DN) (referred to as “SOP data request field”), the assigned address of a designated one of the drive circuits (D1 to DN) (referred to as “the designated drive circuit address”), a CRC code and an EOP field. The designated one of the drive circuits (D1 to DN) is one of the drive circuits (D1 to DN) from which the internal data of the one of the drive circuits (D1 to DN) is to be fetched. Referring to FIG. 8, the data fetch data packet of the temperature fetch signal includes an SOP field for temperature fetch of the temperature sensing circuit (T1) or for obtaining internal data of the temperature sensing circuit (T1) (referred to as “SOP temperature fetch field”), the assigned address of the temperature sensing circuit (T1) (referred to as “the temperature circuit address”), a CRC code and an EOP.

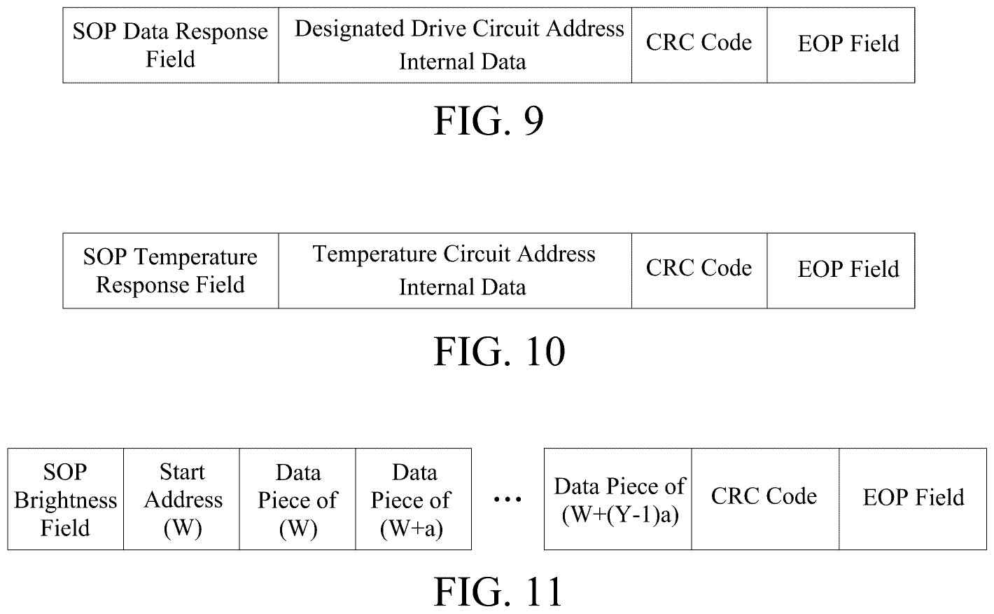

In response to receipt of the data fetch request signal, the designated one of the drive circuits (D1 to DN) generates a data response signal, and transmits the data response signal through the drive circuit string 2, and then to the control circuit 1 via the feedback terminal 15. In this embodiment, the data response signal includes a data response data packet, but the disclosure is not limited in this respect. Referring to FIG. 9, the data response data packet includes an SOP for data response (referred to as “SOP data response field”) that indicates a response to the data fetch request signal, the designated drive circuit address and the internal data of the designated one of the drive circuits (D1 to DN), a CRC code, and an EOP field.

When the temperature sensing circuit (T1) receives the temperature fetch signal, and the temperature circuit address included in the temperature fetch signal conforms with the assigned address of the temperature sensing circuit (T1), the temperature sensing circuit (T1) generates a temperature feedback signal, and transmits the temperature feedback signal through the drive circuit string 2, and to the control circuit 1 via the feedback terminal 15. In this embodiment, the temperature feedback signal includes a temperature response data packet, but the disclosure is not limited in this respect. Referring to FIG. 10, the temperature response data packet includes an SOP for temperature response (referred to as “SOP temperature response field”) that indicates a response to the temperature fetch signal, the temperature circuit address and the internal data (e.g., the temperature value measured by the temperature sensor 28) of the temperature sensing circuit (T1), a CRC code, and an EOP.

In some embodiments where the drive circuit string 2 includes the plurality of temperature sensing circuits (T1 to TK), the data fetch data packet of the temperature fetch signal may include the assigned address of a designated one of the temperature sensing circuits (T1 to TK). The designated one of the temperature sensing circuits (T1 to TK) is one of the temperature sensing circuits (T1 to TK) from which the internal data of the one of temperature sensing circuits (T1 to TK) is to be fetched. In such embodiments, the designated one of the temperature sensing circuits (T1 to TK), in response to receipt of the temperature fetch signal, generates the temperature feedback signal that includes the temperature circuit address and the internal data of the designated one of the temperature sensing circuits (T1 to TK).

The following illustrates an example where the designated one of the drive circuits (D1 to DN) is the second drive circuit (D2). For the second drive circuit (D2), when the first terminal (P1) receives a data fetch request signal, the first decoder 22 decodes the data fetch request signal, and compares the assigned address of the second drive circuit (D2) with the designated drive circuit address included in the data fetch request signal. If the assigned address of the second drive circuit (D2) does not conform with the designated drive circuit address included in the data fetch request signal, the first decoder 22 transmits the data fetch request signal to the multiplexer 21 via the data fetch unit 24. If the assigned address of the second drive circuit (D2) conforms with the designated drive circuit address included in the data fetch request signal, and CRC verification of the data fetch request signal is successful, the first decoder 22 transmits the data fetch request signal that has been decoded to the data fetch unit 24, and generates and transmits a select signal to the multiplexer 21 to control the multiplexer 21 to select a signal from the second input terminal (I2) to be outputted to the signal output terminal (O1). In response to receipt of the data fetch request signal that has been decoded, the data fetch unit 24 fetches the internal data from the register 25, generates a data response signal that corresponds to the data fetch request signal based on the internal data that was fetched, and transmits the data response signal to the second input terminal (I2) of the multiplexer 21.

When the temperature sensing circuit (T1) receives the temperature fetch signal, the way in which the temperature sensing circuit (T1) generates the temperature feedback signal that corresponds to the temperature fetch signal thus received is similar to the abovementioned way of the second drive circuit (D2) generating the data response signal that corresponds to the data fetch request signal in response to receiving the data fetch request signal; therefore, further details thereof will be omitted for the sake of brevity. It should be noted that, since the SOP of the data fetch request signal (i.e., SOP data request field) is different from the SOP of the temperature fetch signal (i.e., SOP temperature fetch field), each of the drive circuits (D1 to DN) is further configured to, in response to receipt of the temperature fetch signal, not perform any action on the temperature fetch signal, and directly transmit the temperature fetch signal to a next one of the functional circuits (IC1 to ICM) via the second terminal (P2) of the drive circuit. The temperature sensing circuit (T1) is further configured to, in response to receipt of the data fetch request signal, not perform any action on the data fetch request signal, and directly output the data fetch request signal via the second terminal (P2) of the temperature sensing circuit (T1). Therefore, even in embodiments that perform the second method of address setting where the assigned address of one of the drive circuits (D1 to DN) may be the same as the assigned address of the temperature sensing circuit (T1), causing the assigned address included in the data fetch request signal or the temperature fetch signal to be the same with the assigned addresses respectively of the one of the drive circuits (D1 to DN) and the temperature sensing circuit (T1), the control circuit 1 is still able to correctly fetch the internal data of the designated one of the drive circuits (D1 to DN) or the temperature sensing circuit (T1). Each of the functional circuits (IC1 to ICM) is further configured to, in response to receipt of the data response signal or the temperature feedback signal, output the data response signal or the temperature feedback signal through the second terminal (P2) of the functional circuit.

A brightness control operation of the first embodiment of the control system of the disclosure is described below. When the control circuit 1 transmits a brightness control signal to the functional circuits (IC1 to ICM) via the control terminal 12, for each of the drive circuits (D1 to DN), the second decoder 26 receives the brightness control signal via the third terminal (P3). In this embodiment, the brightness control signal includes a brightness control data packet, but the disclosure is not limited in this respect. Referring to FIG. 11, the brightness control data packet includes an SOP field for brightness control (referred to as “SOP brightness field”), a start address (W), Y number of data piece(s), a CRC code, and an EOP field, where 1≤Y≤N. The start address (W) corresponds to the assigned address of a W^{th} one of the functional circuits (IC1 to ICM) to receive a first one of the Y number of data piece(s), and the Y number of data piece(s) correspond respectively to Y number of assigned addresses of Y number of functional circuits (IC1 to ICM). For example, the Y number of assigned addresses are (W), (W+a), (W+2a), . . . , (W+(Y−1)a), where “a” represents the first preset value. X number of data piece(s) among the Y number of data piece(s) correspond respectively to X number of assigned address(es) among the assigned address(es) of the drive circuits (D1 to DN), where 1≤X≤Y≤N, thereby causing X number of drive circuit(s) among the drive circuits (D1 to DN) to respectively read the X number of data piece(s) based on the X number of assigned address(es). For illustration purposes, X is taken to be greater than 1 hereinafter, but is not limited to such. Specifically, the X number of data pieces respectively include X number of brightness data sets, and the X number of drive circuits respectively obtain the X number of brightness data sets based on the X number of assigned addresses.

In detail, the second decoder 26 of each of the X number of drive circuits receives the brightness control signal through the third terminal (P3) of the drive circuit, decodes the brightness control signal, and obtains, based on the start address (W), the Y number of assigned addresses that respectively correspond to the Y number of data pieces. The second decoder 26 of the corresponding drive circuit (i.e., the drive circuit that includes the second decoder 26) then reads one of the X number of data pieces that corresponds with the assigned address of the corresponding drive circuit, and obtains one of the X number of brightness data sets included in the one of the X number of data pieces. When CRC verification of the brightness control signal is successful, the second decoder 26 of the corresponding drive circuit transmits the one of the X number of brightness data sets to the brightness control unit 27 of the corresponding drive circuit. The brightness control unit 27 then generates a driving current based on the one of the X number of brightness data sets, and transmits the driving current to a respective one of the light emitting components 3. When the CRC verification is not successful, the second decoder 26 will not transmit the one of the X number of brightness data sets to the brightness control unit 27, and the brightness control unit 27 maintains use of the last brightness data set received thereby to transmit a driving current correspondingly to the respective one of the light emitting components 3.

It should be mentioned that, P number of drive circuit(s) among the drive circuits (D1 to DN) correspond to the temperature sensing circuit (T1), where P is a positive integer, and M>N≥P. For example, P number of the light emitting component(s) 3 that respectively correspond to the P number of drive circuit(s) are arranged around the temperature sensing circuit (T1). In this embodiment, the control circuit 1 is further configured to receive the temperature value from the temperature sensing circuit (T1), and adjust P number of brightness data set(s) among the N number of brightness data sets based on the temperature value thus received, where the P number of brightness data set(s) correspond respectively to the P number of drive circuit(s). For ease of illustration, hereinafter, P is taken to be greater than 1 for example, but the disclosure is not limited to such. For each of the P number of brightness data sets, the control circuit 1 adjusts the brightness data set by multiplying the brightness data set with one of the calibration factors stored in the storage unit 13. Specifically, the control circuit 1 obtains the one of the calibration factors by comparing the temperature value received from the temperature sensing circuit (T1) with the reference temperatures in the lookup table 131 stored in the storage unit 13, and based on one of the reference temperatures that matches with the temperature value, the control circuit 1 obtains the one of the calibration factors that corresponds to the one of the reference temperatures. The control circuit 1 then transmits the N number of brightness data sets including the P number of brightness data sets that have been adjusted to the drive circuits (D1 to DN) in order for the drive circuits (D1 to DN) to respectively drive the N number of light emitting components 3 to emit light based on the N number of brightness data sets. By virtue of this arrangement, those light emitting components 3 respectively corresponding to the P number of drive circuits are able to emit light at a required brightness that is consistent at different temperatures according respectively to the P number of brightness data sets that have been adjusted.

In embodiments where the drive circuit string 2 includes the plurality of temperature sensing circuits (T1 to TK), the control circuit 1 is further configured to receive the temperature values respectively from the temperature sensing circuits (T1 to TK), obtain a temperature gradient based on the temperature values thus received, and adjust the N number of brightness data sets based on the temperature gradient thus obtained. For example, when the number of the temperature sensing circuits (T1 to TK) is 2 (i.e., K=2), and temperature values received by the control circuit 1 are respectively denoted as Tk1 and Tk2, the control circuit 1 calculates the temperature gradient that represents a temperature change between areas where the temperature sensing circuit (T1) and the temperature sensing circuit (T2) are respectively placed (i.e., the temperature change along a distance between the temperature sensing circuit (T1) and the temperature sensing circuit (T2)) based on the temperature values thus received (i.e., Tk1 and Tk2), so that the N number of brightness data sets are adjusted according to the temperature gradient. For example, the temperature change may be caused by different heat dissipation levels in the areas where the temperature sensing circuits are respectively placed. By virtue of this arrangement, the N number of light emitting components 3 are able to emit light at the required brightness.

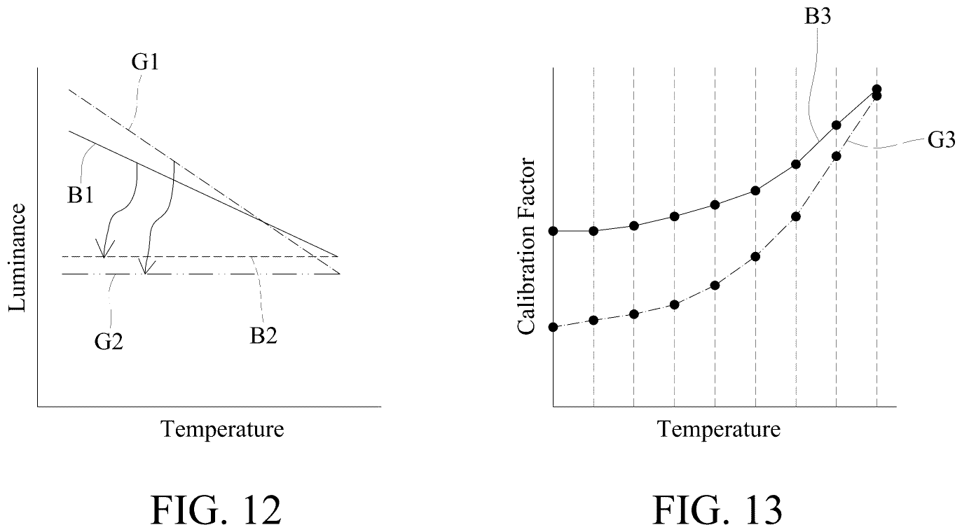

In some other embodiments, the light emitting components 3 may be emitting light of different colors. In such embodiments, the relationship between the reference temperatures and the calibration factors may be different. Referring to FIG. 12, line B1 represents a relationship between a luminance and a temperature of the light emitting components 3 that emit blue light under constant driving current, and line B2 represents a relationship between the luminance after the brightness data sets are adjusted based on the calibration factors and the temperature of the light emitting components 3 that emit blue light; line G1 represents a relationship between a luminance and a temperature of the light emitting components 3 that emit green light under constant driving current, and line G2 represents a relationship between the luminance after the brightness data sets are adjusted based on the calibration factors and the temperature of the light emitting components 3 that emit green light. In yet other embodiments, the relationships between the reference temperatures and the calibration factors may differ for different light emitting components 3, and the disclosure is not limited in this respect.

Further referring to FIG. 13, line B3 represents a relationship between the calibration factor and the temperature for the light emitting components 3 that emit blue light, and line G3 represents a relationship between the calibration factor and the temperature for the light emitting components 3 that emit green light. The relationship between the calibration factor and the temperature can be divided into multiple temperature intervals (e.g., a temperature interval is set as every 5° C.), and each temperature interval may correspond to an individual calibration factor with respect to a temperature linear change slope, so that the driving current of each light emitting component 3 can be finely adjusted according to different temperature intervals.

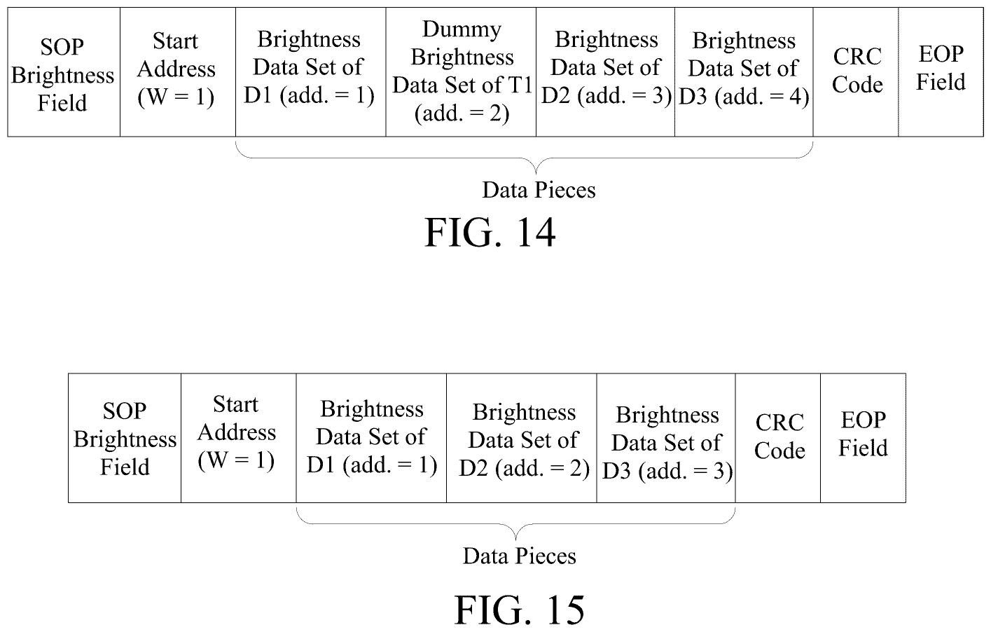

It should be noted that, if the first method of address setting is used, after the assigned address for each of the functional circuits (IC1 to ICM) is set, since the assigned address of the temperature sensing circuit (T1) is in between two of the assigned addresses of the drive circuits (D1 to DN), the assigned addresses of the drive circuits (D1 to DN) are not set in a continuous manner, where the continuous manner refers to a difference between two consecutive assigned addresses of the drive circuits (D1 to DN) being equal to the first preset value. Therefore, the Y number of data pieces of the brightness control signal need to further include a dummy brightness data set that corresponds to the temperature sensing circuit (T1) in addition to the X number of data pieces. For example, if the first preset value is 1, the assigned addresses of the drive circuits (D1 to DN) that are in the continuous manner are respectively 1, 2, 3, to N. However, in the first embodiment, since the temperature sensing circuit (T1) is located in between the first drive circuit (D1) and the second drive circuit (D2), the assigned addresses of the drive circuits (D1 to DN) are respectively 1, 3, 4, to N, where the difference between the assigned addresses 1 and 3 is greater than the first preset value (i.e., 1), thereby causing the assigned addresses of the drive circuits (D1 to DN) to not be in the continuous manner. Referring to FIGS. 2 and 14, taking the assigned address of the first drive circuit (D1) as 1 and the first preset value as 1 for example, when the X number of data pieces included in the brightness control signal include data pieces that correspond respectively to a first three of the drive circuits (D1, D2, D3), the control circuit 1 is further configured to generate the dummy brightness data set that corresponds to the assigned address of the temperature sensing circuit (T1), and include the dummy brightness data set in the brightness control signal. Then, the control circuit 1 transmits the brightness data sets and the dummy brightness data set sequentially to the drive circuit string 2 based on the assigned addresses respectively of the functional circuits (IC1 to ICM). Specifically, in this embodiment, the dummy brightness data set is located in between the data pieces that correspond respectively to the assigned addresses of the first drive circuit (D1) and the second drive circuit (D2), and a value of the dummy brightness data set can be of any value. Referring to FIG. 15, if the assigned address for each of the functional circuits (IC1 to ICM) is set by way of the control system performing the second method of address setting, since the assigned addresses respectively of the drive circuits (D1 to DN) are in the continuous manner, the control circuit 1 does not need to generate the dummy brightness data set to be included in the brightness control signal, and the control circuit 1 transmits the brightness data sets sequentially to the drive circuit string 2 based on the assigned addresses of the drive circuits (D1 to DN).

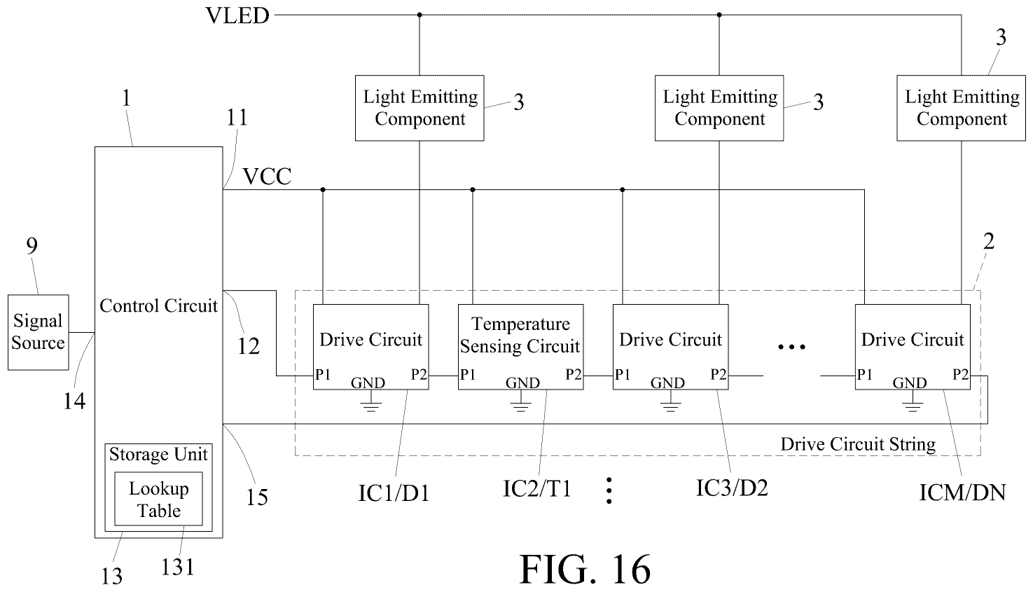

Referring to FIG. 16, the control system according to a second embodiment of the disclosure is presented. The second embodiment differs from the first embodiment in that, the control circuit 1 performs the brightness control operation and the data fetch operation of the drive circuit string 2 only through the control terminal 12. Furthermore, the second embodiment differs from the first embodiment in internal component structures of the drive circuits (D1 to DN) and the temperature sensing circuit (T1), as well as actions within the data fetch operation and the brightness control operation.

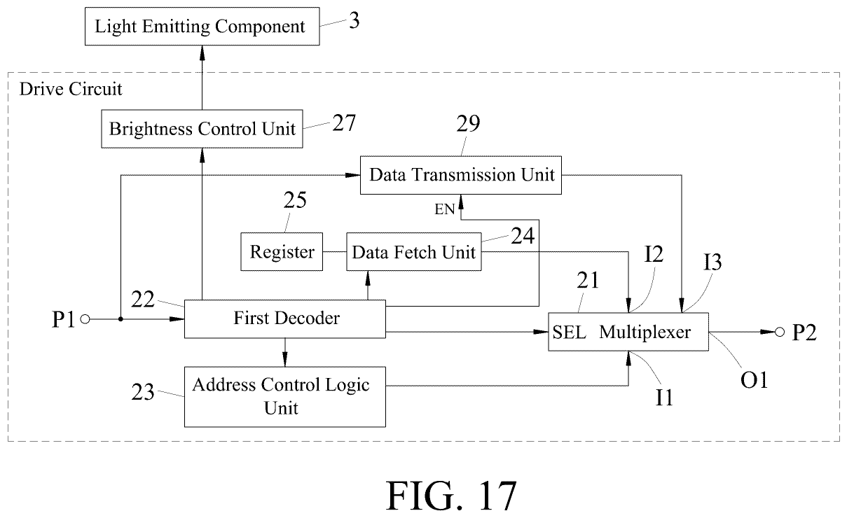

Further referring to FIG. 17, in the second embodiment, each of the drive circuits (D1 to DN) includes a first terminal (P1), a second terminal (P2), a multiplexer 21, a first decoder 22 electrically connected to the first terminal (P1), an address control logic unit 23, a data fetch unit 24, a register 25 that stores internal data (e.g., brightness data, the voltage margin, and the LED open/short circuit status of the corresponding one of the light emitting components 3) of the drive circuit, a data transmission unit 29, and a brightness control unit 27.

The multiplexer 21 includes a first input terminal (I1), a second input terminal (I2), a third input terminal (I3), a select terminal (SEL), and a signal output terminal (O1) that is electrically connected to the second terminal (P2) of the drive circuit. The multiplexer 21 is configured to select a signal from one of the first input terminal (I1), the second input terminal (I2), and the third input terminal (I3) to be transmitted to the signal output terminal (O1) based on a select signal received by the select terminal (SEL). The address control logic unit 23 is electrically connected to the first decoder 22, and the first input terminal (I1) of the multiplexer 21. The data fetch unit 24 is electrically connected to the register 25, the first decoder 22, and the second input terminal (I2) of the multiplexer 21. The brightness control unit 27 is electrically connected to the first decoder 22, and a corresponding one of the light emitting components 3. The brightness control unit 27 is configured to generate a driving current, and transmit the driving current to the corresponding one of the light emitting components 3 to drive the corresponding one of the light emitting components 3 to emit light based on the driving current. The data transmission unit 29 is electrically connected to the first terminal (P1), the third input terminal (I3) of the multiplexer 21, and the first decoder 22.

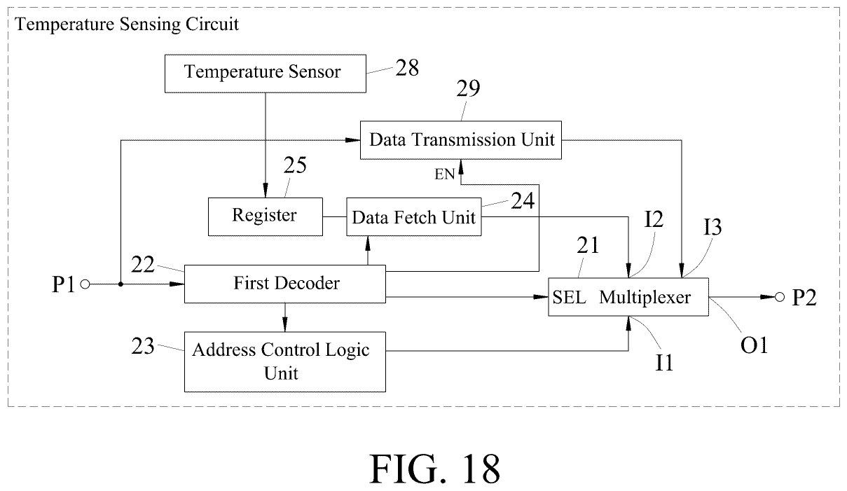

Further referring to FIG. 18, the temperature sensing circuit (T1) includes a first terminal (P1) and a second terminal (P2), a first decoder 22 electrically connected to the first terminal (P1), a multiplexer 21, an address control logic unit 23, a data fetch unit 24, a register 25 that stores internal data (e.g., temperature data) of the temperature sensing circuit (T1), a temperature sensor 28, and a data transmission unit 29. The temperature sensor 28 is electrically connected to the register 25. Electrical connections amongst the first decoder 22, the multiplexer 21, the address control logic unit 23, the data fetch unit 24, the data transmission unit 29, and the register 25 of the second embodiment are similar to the electrical connections of aforementioned components in each of the drive circuits (D1 to DN) of the second embodiment, and descriptions thereof will be omitted for the sake of brevity.

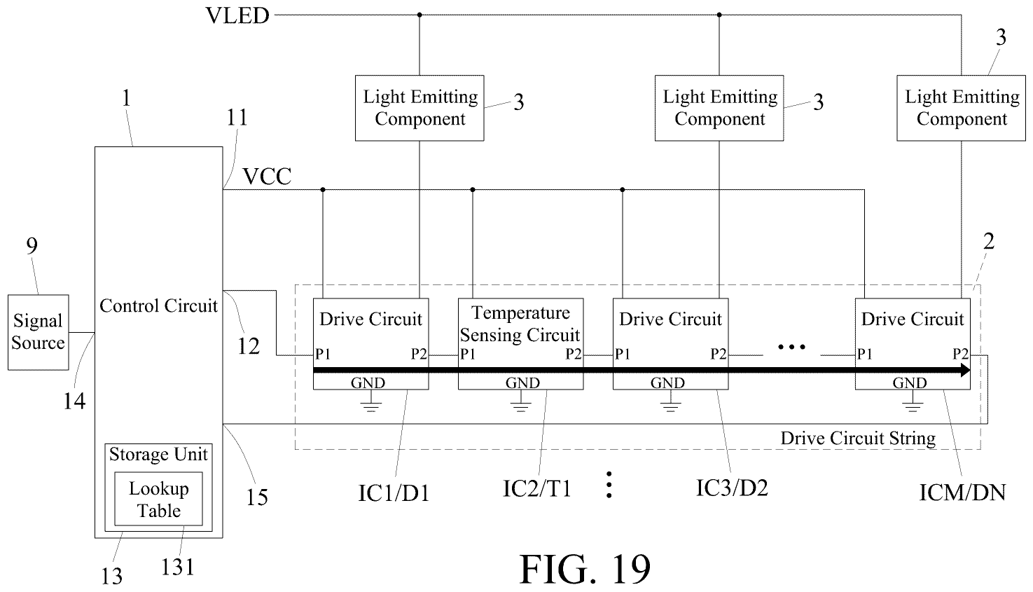

In the second embodiment, the control circuit 1 transmits the starting address setting signal to the drive circuit string 2 via the control terminal 12 to set the assigned address of each of the functional circuits (IC1 to ICM). Since the address setting operation performed by the second embodiment is similar to that of the first embodiment, further descriptions thereof will be omitted for the sake of brevity. Further referring to FIG. 19, in the second embodiment, each of the functional circuits (IC1 to ICM) has a state setting related to signal transmission between the first terminal (P1) and the second terminal (P2) thereof. For each of the functional circuits (IC1 to ICM), when the setting of the assigned address of the functional circuit is completed, the state setting of the functional circuit is switched into a transmission state where a signal outputted by the second terminal (P2) of the functional circuit is received from the first terminal (P1) of the functional circuit, and has content identical to content of a signal inputted into the first terminal (P1) of the functional circuit. Specifically, for each of the functional circuits (IC1 to ICM), the first decoder 22 is configured to, after the setting of the assigned address of the functional circuit is completed and the address setting output signal has been transmitted to a next one of the functional circuits (IC1 to ICM), generate an enabling signal (EN) and transmit the enabling signal (EN) to the data transmission unit 29. In response to the data transmission unit 29 receiving the enabling signal (EN), the functional circuit switches into the transmission state, and the signal received in an input terminal of the data transmission unit 29 is outputted at an output terminal of the data transmission unit 29. For example, after the first functional circuit (IC1) has transmitted the address setting output signal to the second functional circuit (IC2), the first decoder 22 of the first functional circuit (IC1) generates the enabling signal (EN), and transmits the enabling signal (EN) to the data transmission unit 29. Then, the first decoder 22 controls the multiplexer 21 to select a signal received from the data transmission unit 29 to be outputted to the second terminal (P2) of the first functional circuit (IC1). The functional circuits (IC1 to ICM) form a pass-through signal transmission path 4 between the first terminal (P1) of the first functional circuit (IC1) and the second terminal (P2) of the last functional circuit (ICM) when the state setting of every single one of the functional circuits (IC1 to ICM) is in the transmission state. The data transmission unit 29 is exemplified by, for example, a switch, a buffer with a switch function, a flip-flop, or a combination thereof, but the disclosure is not limited in this respect.

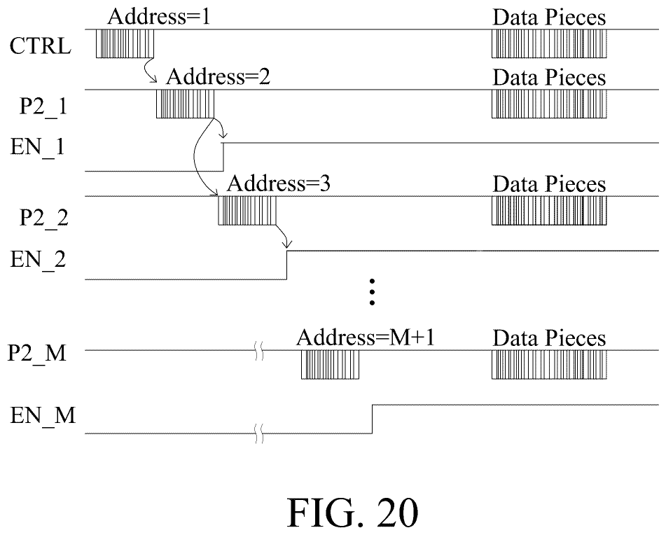

Referring to FIGS. 19 and 20, “CTRL” denotes a signal transmitted from the control circuit 1 to the first functional circuit (IC1). “P2_1”, “P2_2”, and “P2_M” denote signals outputted respectively from the first functional circuit (IC1), the second functional circuit (IC2), and the last functional circuit (ICM). “EN_1”, “EN_2”, and “EN_M” denote signals that the data transmission units 29 respectively of the first functional circuit (IC1), the second functional circuit (IC2), and the last functional circuit (ICM) receive from the corresponding first decoders 22.

In the second embodiment, when the control circuit 1 transmits the data fetch request signal or the temperature fetch signal to the drive circuit string 2 after the functional circuits (IC1 to ICM) have formed the pass-through signal transmission path 4, the data fetch request signal or the temperature fetch signal is transmitted to the functional circuits (IC1 to ICM) through the pass-through signal transmission path 4. The functional circuits (IC1 to ICM) then transmit the data response signal or the temperature feedback signal that is generated by one of the functional circuits (IC1 to ICM) to the next one of the functional circuits (IC1 to ICM) and finally to the second terminal (P2) of the last functional circuit (ICM) through the pass-through signal transmission path 4. The control circuit 1 then receives the data response signal or the temperature feedback signal through the feedback terminal 15.

In the second embodiment, when the control circuit 1 transmits the brightness control signal to the drive circuit string 2 after the functional circuits (IC1 to ICM) have formed the pass-through signal transmission path 4, the brightness control signal is transmitted to each of the functional circuits (IC1 to ICM) via the pass-through signal transmission path 4. For each of the X number of the drive circuits (IC1 to ICM), the first decoder 22 decodes the brightness control signal, and reads one of the X number of data pieces to obtain a corresponding one of the X number of brightness data pieces based on the assigned address of the drive circuit. The brightness control units 27 respectively of the X number of the drive circuits (D1 to DN) then generate the driving currents and transmit the driving currents respectively to the light emitting components 3 based on the brightness data sets thus respectively obtained.

In summary, by virtue of the temperature sensing circuit (T1) being located in the drive circuit string 2, the control circuit 1 is able to obtain the calibration factors for adjusting the brightness data sets according to the temperature value received from the temperature sensing circuit (T1) without the need of additional wiring and additional circuit board layers. By way of this arrangement, the control system of this disclosure is able to achieve temperature compensation without increasing circuit and wiring complexity.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A control system for a light emitting device with temperature compensation function, comprising:
a control circuit including a control terminal, and configured to receive display data from a signal source, and generate N number of brightness data sets that correspond respectively to N number of light emitting components based on the display data thus received, where N>1; and
a drive circuit string including M number of functional circuits, said M number of functional circuits including
N number of drive circuits that correspond respectively to the N number of brightness data sets, and that are configured to respectively drive the N number of light emitting components, and
at least one temperature sensing circuit configured to output at least one temperature value, each of which indicates a temperature of a surrounding in which a corresponding one of said at least one temperature sensing circuit is placed, each of said N number of drive circuits and said at least one temperature sensing circuit being one of said M number of functional circuits, P number of drive circuit(s) among said N number of drive circuits corresponding to said at least one temperature sensing circuit, where M and P are positive integers, and M>N≥P,
wherein each of said M number of functional circuits includes a first terminal and a second terminal, said M number of functional circuits being sequentially connected in series via said first terminal and said second terminal of each of said M number of functional circuits, said first terminal of a first one of said M number of functional circuits being electrically connected to said control terminal,
wherein said control circuit is further configured to receive the at least one temperature value from said at least one temperature sensing circuit of said drive circuit string, adjust P number of brightness data set(s) among the N number of brightness data sets based on the at least one temperature value thus received, and transmit the N number of brightness data sets including the P number of brightness data set(s) that have been adjusted to said N number of drive circuits in order for said N number of drive circuits to respectively drive the N number of light emitting components to emit light based on the N number of brightness data sets, the P number of brightness data set(s) corresponding respectively to said P number of drive circuit(s).

2. The control system as claimed in claim 1, wherein, for each positive integer m such that 2≤m≤M, said first terminal of an m^{th} one of said M number of functional circuits is electrically connected to said second terminal of an (m−1)^{th} one of said M number of functional circuits;
wherein said at least one temperature sensing circuit includes a plurality of temperature sensing circuits, and the at least one temperature value includes a plurality of temperature values respectively outputted by said plurality of temperature sensing circuits, each of said N number of drive circuits and said plurality of temperature sensing circuits being one of said M number of functional circuits; and
wherein said control circuit is further configured to receive the plurality of temperature values respectively from said plurality of temperature sensing circuits, obtain a temperature gradient based on the plurality of temperature values thus received, adjust the N number of brightness data sets based on the temperature gradient thus obtained, and transmit the N number of brightness data sets that have been adjusted to said N number of drive circuits in order for said N number of drive circuits to respectively drive the N number of light emitting components to emit light based on the N number of brightness data sets that have been adjusted.

3. The control system as claimed in claim 1, wherein, for each positive integer m such that 2≤m≤M, said first terminal of an m^{th} one of said M number of functional circuits is electrically connected to said second terminal of an (m−1)^{th} one of said M number of functional circuits;
wherein said control circuit is further configured to transmit a starting address setting signal to said drive circuit string via said control terminal, the starting address setting signal including a preset starting address;
wherein said drive circuit string is configured to sequentially set an assigned address for each of said M number of functional circuits based on the preset starting address included in the starting address setting signal, the N number of brightness data sets corresponding respectively to the assigned addresses respectively of said N number of drive circuits; and
wherein said control circuit is further configured to generate a dummy brightness data set that corresponds to the assigned address of said at least one temperature sensing circuit, and transmit the N number of brightness data sets and the dummy brightness data set sequentially to said drive circuit string based on the assigned addresses respectively of said M number of functional circuits.

4. The control system as claimed in claim 3, wherein, for each positive integer i such that 1≤i≤M, an i^{th} one of said M number of functional circuits is configured to, in response to receipt of an address setting input signal that includes an input setting address via said first terminal of said i^{th} one of said M number of functional circuits, set the assigned address of said i^{th} one of said M number of functional circuits based on the input setting address, obtain an output setting address by adding a preset value to the input setting address, generate an address setting output signal that includes the output setting address, and output the address setting output signal to said second terminal of said i^{th} one of said M number of functional circuits;
wherein for said m^{th} one of said M number of functional circuits, the address setting output signal outputted by said (m−1)^{th} one of said M number of functional circuits serves as the address setting input signal that is to be received by said first terminal of said m^{th} one of said M number of functional circuits, and the output setting address included in the address setting output signal outputted by said (m−1)^{th} one of said M number of functional circuits serves as the input setting address for setting the assigned address of said m^{th} one of said M number of functional circuits; and
wherein for said first one of said M number of functional circuits, the starting address setting signal transmitted by said control circuit via said control terminal serves as the address setting input signal that is to be received by said first terminal of said first one of said M number of functional circuits, and the preset starting address included in the starting address setting signal serves as the input setting address for setting the assigned address of said first one of said M number of functional circuits.

5. The control system as claimed in claim 1, wherein, for each positive integer m such that 2≤m≤M, said first terminal of an m^{th} one of said M number of functional circuits is electrically connected to said second terminal of an (m−1)^{th} one of said M number of functional circuits;
wherein said control circuit is further configured to transmit a starting address setting signal to said drive circuit string via said control terminal, the starting address setting signal including a preset starting address;
wherein said drive circuit string is configured to sequentially set an assigned address for each of said N number of drive circuits based on the preset starting address included in the starting address setting signal, the assigned addresses respectively of said N number of drive circuits forming an arithmetic sequence, the N number of brightness data sets corresponding respectively to the assigned addresses of said N number of drive circuits; and
wherein said control circuit is further configured to transmit the N number of brightness data sets sequentially to said drive circuit string based on the assigned addresses of said N number of drive circuits.

6. The control system as claimed in claim 5, wherein, for each positive integer i such that 1≤i≤M, an i^{th} one of said M number of functional circuits is configured to, in response to receipt of an address setting input signal that includes an input setting address via said terminal of said i^{th} one of said M number of functional circuits, set the assigned address of said i^{th} one of said M number of functional circuits based on the input setting address, obtain an output setting address based on the input setting address, generate an address setting output signal that includes the output setting address, and output the address setting output signal to said second terminal of said i^{th} one of said M number of functional circuits;
wherein for said m^{th} one of said M number of functional circuits, the address setting output signal outputted by said (m−1)^{th} one of said M number of functional circuits serves as the address setting input signal that is to be received by said first terminal of said m^{th} one of said M number of functional circuits, and the output setting address included in the address setting output signal outputted by said (m−1)^{th} one of said M number of functional circuits serves as the input setting address for setting the assigned address of said m^{th} one of said M number of functional circuits;
wherein for said first one of said M number of functional circuits, the starting address setting signal outputted by said control circuit via said control terminal serves as the address setting input signal that is to be received by said first terminal of said first one of said M number of functional circuits, and the preset starting address included in the starting address setting signal serves as the input setting address for setting the assigned address of said first one of said M number of functional circuits;
wherein said i^{th} one of said M number of functional circuits is configured to, in a case where said i^{th} one of said M number of functional circuits is one of said N number of drive circuits, set the assigned address of said i^{th} one of said M number of functional circuits based on the input setting address included in the address setting input signal thus received, and obtain the output setting address by adding a first preset value to the input setting address; and
wherein said i^{th} one of said M number of functional circuits is configured to, in a case where said i^{th} one of said M number of functional circuits is said at least one temperature sensing circuit, obtain a temperature setting address by adding a second preset value to the input setting address, set the assigned address of said i^{th} one of said M number of functional circuits based on the temperature setting address, and obtain the output setting address by setting the input setting address as the output setting address.

7. The control system as claimed in claim 1, further comprising a storage unit storing a plurality of reference temperatures that correspond respectively to a plurality of calibration factors,
wherein said control circuit is further configured to, in response to receipt of the at least one temperature value that matches one of the plurality of reference temperatures, adjust the P number of brightness data set(s) by multiplying the P number of brightness data set(s) with one of the plurality of calibration factors that corresponds with said one of the plurality of reference temperatures.

8. The control system as claimed in claim 1, wherein, for each positive integer m such that 2≤m≤M, said first terminal of an m^{th} one of said M number of functional circuits is electrically connected to said second terminal of an (m−1)^{th} one of said M number of functional circuits, and said control circuit further includes a feedback terminal electrically connected to said second terminal of a last one of said M number of functional circuits;
wherein said control circuit is further configured to transmit a starting address setting signal to said drive circuit string via said control terminal, the starting address setting signal including a preset starting address;
wherein said drive circuit string is configured to sequentially set an assigned address for each of said M number of functional circuits based on the preset starting address included in the starting address setting signal;
wherein said control circuit is further configured to, after the setting of the assigned address of each of said M number of functional circuits is completed, transmit a temperature fetch signal to said drive circuit string, the temperature fetch signal including the assigned address of said at least one temperature sensing circuit;
wherein said at least one temperature sensing circuit is configured to, in response to receipt of the temperature fetch signal, output the at least one temperature value to said second terminal of said at least one temperature sensing circuit;
wherein each of said N number of drive circuits is further configured to, in response to receipt of the temperature fetch signal, output the temperature fetch signal via said second terminal of the drive circuit; and
wherein each of said N number of drive circuits is further configured to, in response to receipt of the at least one temperature value outputted by said at least one temperature sensing circuit, output the at least one temperature value via said second terminal of the drive circuit, so that said control circuit receives the at least one temperature value via said feedback terminal.

9. The control system as claimed in claim 1, wherein, for each positive integer m such that 2≤m≤M, said first terminal of an m^{th} one of said M number of functional circuits is electrically connected to said second terminal of an (m−1)^{th} one of said M number of functional circuits, said control circuit further includes a feedback terminal electrically connected to said second terminal of a last one of said M number of functional circuits, and each of said M number of functional circuits further includes a register that stores internal data of the functional circuit;
wherein said control circuit is further configured to transmit a starting address setting signal to said drive circuit string via said control terminal, the starting address setting signal including a preset starting address;
wherein said drive circuit string is configured to sequentially set an assigned address for each of said M number of functional circuits based on the preset starting address included in the starting address setting signal;
wherein each of said M number of functional circuits has a state setting related to signal transmission between said first terminal and said second terminal thereof;
wherein for each of said M number of functional circuits, in response to the setting of the assigned address of the functional circuit being completed, the state setting of the functional circuit is switched into a transmission state where a signal outputted by said second terminal of the functional circuit is received from said first terminal of the functional circuit, and has content identical to content of a signal inputted into said first terminal of the functional circuit; and
wherein said M number of functional circuits form a pass-through signal transmission path between said first terminal of said first one of said M number of functional circuits and said second terminal of said last one of said M number of functional circuits in response to the state setting of every single one of said M number of functional circuits being in the transmission state.

10. The control system as claimed in claim 9, wherein said control circuit is further configured to, after the setting of the assigned address of each of said M number of functional circuits is completed, transmit a brightness control signal to said drive circuit string, the brightness control signal including X number of data piece(s) that correspond respectively to X number of assigned address(es) among the assigned addresses of said N number of drive circuits, where 1≤X≤N, thereby causing X number of drive circuit(s) among said N number of drive circuits to respectively read the X number of data piece(s) based on the X number of assigned address(es).

11. The control system as claimed in claim 9, wherein said control circuit is further configured to, after the setting of the assigned address of each of said M number of functional circuits is completed, transmit a data fetch request signal to said drive circuit string, the data fetch request signal being transmitted to each of said M number of functional circuits via the pass-through signal transmission path and including the assigned address of one of said N number of drive circuits; and
wherein said one of said N number of drive circuits is further configured to, in response to receipt of the data fetch request signal, generate a data response signal and transmit the data response signal to said feedback terminal via the pass-through signal transmission path, the data response signal including the internal data of said one of said N number of drive circuits.

12. The control system as claimed in claim 9, wherein said control circuit is further configured to, after the setting of the assigned address of each of said M number of functional circuits is completed, transmit a temperature fetch signal to said drive circuit string, the temperature fetch signal being transmitted to each of said M number of functional circuits via the pass-through signal transmission path, and including the assigned address of said at least one temperature sensing circuit; and
wherein said at least one temperature sensing circuit is configured to, in response to receipt of the temperature fetch signal, generate a temperature feedback signal and transmit the temperature feedback signal to said control circuit through the pass-through signal transmission path, the temperature feedback signal including the internal data of said at least one temperature sensing circuit.
